(19) United States
(12) Patent Application Publication
(10) Pub. No.: US 2019/0355177 A1
(43) Pub. Date: Nov. 21, 2019

(54) BUILDING SYSTEM MAINTENANCE USING MIXED REALITY

(71) Applicant: Honeywell International Inc., Morris Plains, NJ (US)

(72) Inventors: Raveendran Manickam, Salem (IN); Jayaprakash Meruva, Bangalore (IN); Rajesh Kulandaivel Sankarapandian, Madurai (IN); Kirupakar Janakiraman, Madurai (IN); Paramesh Muthuraj, Salem (IN); Ganesh Kaliaraj, Andalpuram (IN)

(21) Appl. No.: 15/980,520

(22) Filed: May 15, 2018

(51) Int. Cl. G06T 19/00; G06F 17/50; G02B 27/01

(52) U.S. Cl. CPC G06T 19/006; G06F 17/5013; G02B 27/0172; G02B 2027/0138; G02B 2027/0141; G02B 2027/0196; G02B 27/0103

(57) ABSTRACT

Methods, devices, and systems for building system maintenance using mixed reality are described herein. One mixed reality computing device for building system maintenance can include a mixed reality display, a memory, and a processor to execute executable instructions stored in the memory to receive a work order for a device in a building, determine a location of the mixed reality computing device in the building, and display virtual information about the device on the mixed reality display based on the location of the mixed reality computing device in the building, where the displayed virtual information includes information about fixing a fault of the device, and where the virtual information displayed on the mixed reality display is overlaid over an area of the mixed reality display based on a field of view of the mixed reality computing device.

### TECHNICAL FIELD

The present disclosure relates to methods, devices, and systems for building system maintenance using mixed reality.

### BACKGROUND

Building systems can be installed in a building to manage aspects of the building. Building systems can include, for example, heating, ventilation, and air conditioning (HVAC) systems, access control systems, security systems, lighting systems, and fire systems, among others. A building system can refer a single building system (e.g., an HVAC system) or multiple building systems. A building management system (BMS) can manage a system in a single building, multiple systems in a single building, and/or multiple systems across a number of buildings.

Maintenance of building systems can be accomplished by various users. For example, building maintenance personnel may perform maintenance on various devices included in building systems. Additionally, other users such as technicians and/or engineers may perform maintenance on various devices in building systems. In some examples, engineers and/or technicians from a manufacturer of a device may travel to a site of the building to perform maintenance on various devices in building systems.

### BRIEF DESCRIPTION OF THE DRAWINGS

FIG. 1 illustrates an example of a building for building system maintenance using mixed reality, in accordance with one or more embodiments of the present disclosure.

FIG. 2 illustrates an example of a mixed reality display, in accordance with one or more embodiments of the present disclosure.

FIG. 3A illustrates an example of a mixed reality display including a device, in accordance with one or more embodiments of the present disclosure.

FIG. 3B illustrates an example of a mixed reality display including displayed virtual information, in accordance with one or more embodiments of the present disclosure.

FIG. 4A illustrates an example of a mixed reality display including steps of a standard operating procedure (SOP), in accordance with one or more embodiments of the present disclosure.

FIG. 4B illustrates an example of a mixed reality display including updating the steps of the SOP, in accordance with one or more embodiments of the present disclosure.

FIG. 5 illustrates an example mixed reality computing device for building system maintenance using mixed reality, in accordance with one or more embodiments of the present disclosure.

### DETAILED DESCRIPTION

Devices, methods, and systems for building system maintenance using mixed reality are described herein. For example, a mixed reality computing device for building system maintenance can include a mixed reality display, a memory, and a processor to execute executable instructions stored in the memory to receive a work order for a device in a building, determine a location of the mixed reality computing device in the building, and display virtual information about the device on the mixed reality display based on the location of the mixed reality computing device in the building, where the displayed virtual information includes information about fixing a fault of the device, and where the virtual information displayed on the mixed reality display is overlaid over an area of the mixed reality display based on a field of view of the mixed reality computing device.

Building system maintenance can be performed by various users, including maintenance personnel, technicians, engineers, and/or other specialized users such as technicians and/or engineers from a manufacturer of a device utilized in the building. Building system maintenance can include regularly scheduled maintenance, servicing of devices, tuning of devices, validation of devices, and/or trouble shooting devices, among other types of building system maintenance.

During building system maintenance, delays may occur. For example, specialized maintenance technicians may travel to the site of the building to perform building maintenance. Further, a specialized maintenance technician may not be available to travel to the building site because of scheduling, travel time, travel distance, etc. In some examples, on-site technicians, engineers, etc. may not have the expertise to perform certain building system maintenance functions. These or other scenarios may delay the maintenance of a particular device. Delayed maintenance of one device may cause a cascade of other delays as a result of the delay in the maintenance of the particular device. These types of delays may result in damage to building systems, building system downtime, and/or loss of money.

Devices, methods, and systems for building system maintenance using mixed reality described herein can be utilized to enable a user to perform maintenance activities utilizing a mixed reality display. For example, a mixed reality computing device can be utilized to receive a work order and display virtual information about a device included in the work order. A user can utilize the mixed reality computing device to perform activities included in the work order on various devices and/or equipment included in the building. For example, the user can utilize virtual information about the device displayed on a mixed reality display of the mixed reality computing device to perform various maintenance and/or other activities.

Building system maintenance using mixed reality can provide a convenient and manageable approach to building system maintenance. A knowledge gap for users can be overcome so that a user does not have to take time to learn a building layout to find a device for maintenance, learn how to perform maintenance on the device, etc. Additionally, displaying, by the mixed reality computing device, virtual information about a device can allow for easy and intuitive instructions on how to perform maintenance on different building systems in a building, reducing errors and/or maintenance delays which can save costs in building system maintenance.

In the following detailed description, reference is made to the accompanying drawings that form a part hereof. The drawings show, by way of illustration, how one or more embodiments of the disclosure may be practiced.

These embodiments are described in sufficient detail to enable those of ordinary skill in the art to practice one or more embodiments of this disclosure. It is to be understood that other embodiments may be utilized and that process, electrical, and/or structural changes may be made without departing from the scope of the present disclosure.

As will be appreciated, elements shown in the various embodiments herein can be added, exchanged, combined, and/or eliminated so as to provide a number of additional embodiments of the present disclosure. The proportion and the relative scale of the elements provided in the figures are intended to illustrate the embodiments of the present disclosure, and should not be taken in a limiting sense.

The figures herein follow a numbering convention in which the first digit or digits correspond to the drawing figure number and the remaining digits identify an element or component in the drawing.

As used herein, “a” or “a number of” something can refer to one or more such things. For example, “a number of process variables” can refer to one or more process variables.

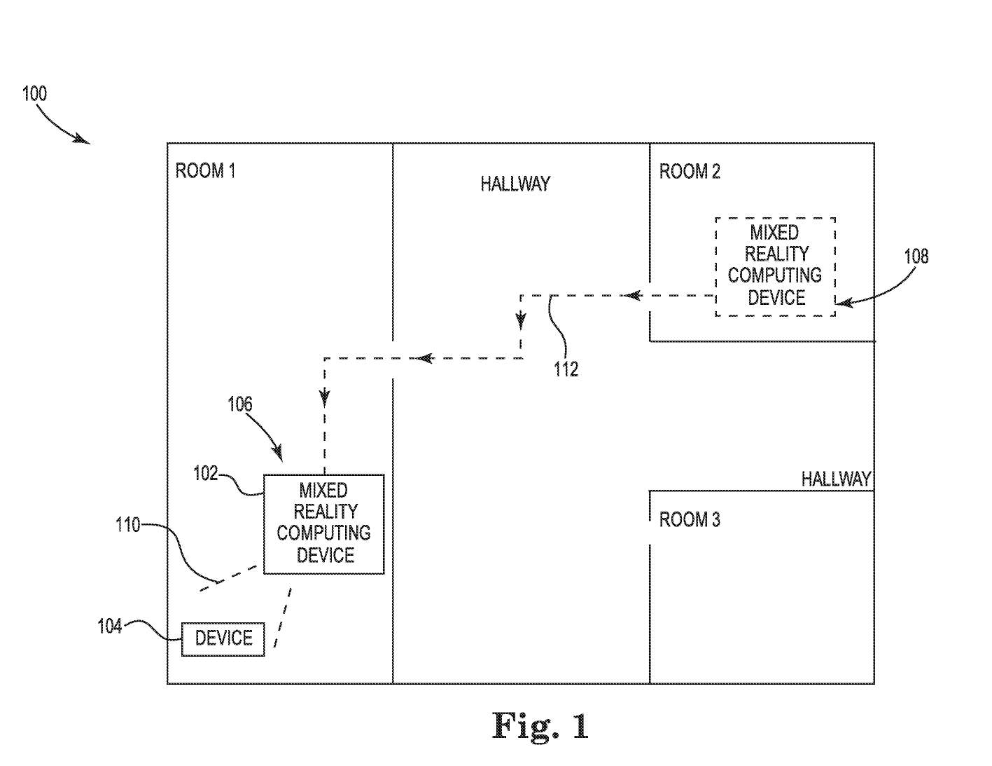

FIG. 1 illustrates an example of a building 100 for building system maintenance using mixed reality, in accordance with one or more embodiments of the present disclosure. As illustrated in FIG. 1, building 100 can include mixed reality computing device 102, device 104, location 106 of mixed reality computing device 102, initial location 108 of mixed reality computing device 108, field of view 110 of mixed reality computing device 102, and directions 112.

As used herein, mixed reality can include the merging of the real physical world and a virtual world to produce a visualization where physical and digital objects can co-exist and interact in real time. Mixed reality can include a mix of reality and virtual reality, encompassing both augmented reality and augmented virtuality via an immersive display. Mixed reality may include a mixed reality holographic object of virtual content overlaid on a visual of real world physical content, where the mixed reality content can be anchored to and interact with the real-world content. For example, the virtual content and real-world content may be able to react to each other in real time.

The mixed reality computing device 102 can include a display. The display can be a transparent mixed reality display. For example, the mixed reality computing device 102 may include a transparent display through which a user may view a physical environment in which the user is located, such as a building, an interior of a building, and/or a device. The transparent display can be, for example, a head mounted display, a handheld display, or a spatial display, among other types of transparent displays.

The mixed reality computing device 102 may also capture physical environment data from the physical environment. The physical environment may include one or more physical objects. Using such physical environment data, a 3-dimensional (3D) transformer may create a mixed reality model of the destination physical environment including the physical objects having associated physical object properties.

The 3D transformer may cause to be displayed a mixed reality hologram using a spatial anchor. The spatial anchor may include a coordinate system that adjusts as needed, relative to other spatial anchors or a frame of reference to keep an anchored mixed reality hologram in place, as is further described herein. The spatial anchor may correspond to a device 104 within the building 100. The mixed reality hologram can include a 3D representation of a device 104, virtual information about the device 104, directions 112 to the device 104, and/or other information, as is further described herein. For example, a user can view the physical environment in which they are located through the transparent mixed reality display with a mixed reality model overlaid on the transparent mixed reality display. The mixed reality model can supplement the view of the physical environment with virtually displayed information. In some examples, the mixed reality model can include a work order for a device in a building 100 and information corresponding thereto, as is further described herein.

Mixed reality computing device 102 can receive a work order. As used herein, the term “work order” refers to a task or job. The work order can be for a heating, ventilation, and air conditioning (HVAC) device 104 in building 100. For example, the HVAC device may have experienced a fault, have routine maintenance to be performed, etc. As used herein, an HVAC device can be a device such as a boiler, chiller, air handling unit (AHU), rooftop unit (RTU), variable air volume (VAV) systems and control devices, and/or heat pumps, sensors, operating panels, controllers, actuators, fans, pumps, valves, coils, and/or radiators, etc. However, the HVAC device is not limited to these examples. Further, although device 104 is described above as an HVAC device, embodiments of the present disclosure are not so limited. For example, device 104 can be a fire suppression device, a security device, a plumbing device, an electrical device, and/or any other building device.

The work order for the HVAC device 104 can be transmitted to mixed reality computing device 102 by, for instance, a building management system via a wired or wireless connection. As used herein, a building management system (BMS) can be used to monitor and/or control a facility (e.g., building). For example, an operator, service technician, or other user can use a BMS check and/or set the state of components of the facility, such as, for instance, control components, equipment (e.g., HVAC equipment), devices, networks, areas, and/or spaces of the building 100. The wired or wireless connection can be a network relationship that connects mixed reality computing device 102 with the building management system. Examples of such a network relationship can include a local area network (LAN), wide area network (WAN), personal area network (PAN), a distributed computing environment (e.g., a cloud computing environment), storage area network (SAN), Metropolitan area network (MAN), a cellular communications network, and/or the Internet, among other types of network relationships.

The work order received by mixed reality computing device 102 can include details of the work order. Work order details can include a type of device 104, a task to be performed on device 104, a location of device 104, and/or safety information associated with an area including the device, among other types of work order details. For example, mixed reality computing device 102 can receive a work order for device 104. For instance, the work order may include cleaning and/or checking the functionality of a smoke detector (e.g., if device 104 is a smoke detector), tuning a field of view of a security camera (e.g., if device 104 is a security camera), checking functionality of an access control system (e.g., if device 104 is an access control system), checking the functionality of intruder alarms (e.g., if device 104 is an intruder alarm), calibrating an HVAC sensor (e.g., if device 104 is an HVAC sensor), performance testing of a public address system (e.g., if device 104 is a public address system), functional testing of a fire suppression system (e.g., if device 104 is a fire suppression system), among other types of maintenance tasks, etc.

Mixed reality computing device 102 can display the details of the work order over a portion of the area of the mixed reality display. For example, mixed reality computing device 102 can display the details of the work order over a portion of the mixed reality display, while the user can simultaneously view the physical environment in which they are located. For example, the user can view information relating to a work order for device 104 (e.g., an HVAC sensor) including the task to be completed (e.g., calibration of the HVAC sensor), the type of device (e.g., a temperature sensor), and/or the location of device 104 (e.g., Room 1 of building 100), safety equipment which should be utilized (e.g., a hard hat, safety glasses, gloves, etc.) while simultaneously viewing the physical environment in which the user is located through the transparent display of mixed reality computing device 102.

Mixed reality computing device 102 can determine its location. For example mixed reality computing device 102 can determine its location within building 100. In the example illustrated in FIG. 1, mixed reality computing device 102 can be at location 106. Location 106 can correspond to Room 1 of building 100.

Mixed reality computing device 102 can determine its location using spatial analytics. As used herein, the term “spatial analytics” refers to determining properties of an area based on topological, geometric, and/or geographic properties of the area. For example, mixed reality computing device 102 can view an area such as Room 1 of building 100 to determine its location based on topological, geometric, and/or geographic properties of Room 1 of building 100.

Mixed reality computing device 102 can view an area using various sensors and systems included with mixed reality computing device 102. For example, mixed reality computing device 102 can include an optical sensor that utilizes at least one outward facing sensor. The outward facing sensor may detect properties of an area within its field of view 110. For example, the outward facing sensor of mixed reality computing device 102 can detect a layout of Room 1, geometric shapes and/or patterns in Room 1, properties of objects in Room 1 (e.g., shape, color, texture, material, etc.), and/or other properties of the area corresponding to Room 1 of building 100.

In some examples, the optical sensor can include a camera that can record photographs and/or video. In some examples, the mixed reality computing device 102 can utilize spatial analytics including analyzing a video feed of the optical sensor. For example, the mixed reality computing device 102 can analyze the video feed of the optical sensor to detect a layout of Room 1, geometric shapes and/or patterns in Room 1, properties of objects in Room 1 (e.g., shape, color, texture, material, etc.), and/or other properties of the area corresponding to Room 1 of building 100.

The mixed reality computing device 102 can compare the analyzed video feed of the camera with a predetermined model of building 100. For example, the mixed reality computing device 102 can determine a layout of Room 1, geometric shapes and/or patterns in Room 1, properties of objects in Room 1 (e.g., shape, color, texture, material, etc.), and/or other properties of the area corresponding to Room 1 of building 100, and compare the Room 1 layout, geometric shapes and patterns in Room 1, the properties of objects in Room 1, and/or other properties of the area corresponding to Room 1 with the predetermined model of building 100 that includes a predetermined model of Room 1. In some examples, the predetermined model of building 100 can be located in a remote server. In some examples, the predetermined model can be included in the BMS.

Although mixed reality computing device 102 is described above as determining its location by viewing an area and comparing the viewed area to a predetermined model, embodiments of the present disclosure are not so limited. For example, the mixed reality computing device 102 can utilize a global positioning system (GPS), Wi-Fi positioning system utilizing wireless access points (APs) (e.g., APs located in building 100), and/or other location determination mechanisms.

As described above, based on the comparison of the viewed area to a predetermined model by analyzing a video feed captured by a camera of mixed reality computing device 102 and matching to the predetermined model, mixed reality computing device 102 can determine its location. For example, based on the layout of Room 1, geometric shapes and/or patterns in Room 1, properties of objects in Room 1 (e.g., shape, color, texture, material, etc.), and/or other properties of the area corresponding to Room 1 of building 100 captured by the camera of mixed reality computing device 102 matching the same of Room 1 included in the predetermined model of building 100, the mixed reality computing device 102 can determine it is located in Room 1 of building 100.

Mixed reality computing device 102 can determine a location of device 104 in building 100. The location of device 104 in building 100 can be used to display virtual information regarding device 104 on the transparent display of mixed reality computing device 102. For example, mixed reality computing device 102 can display virtual information about device 104 when device 104 is in a field of view 110 of mixed reality computing device 102, as is further described herein.

Mixed reality computing device 102 can determine a location of device 104 to display virtual information about device 104 using a spatial anchor. As used herein, the term “spatial anchor” refers to a coordinate system determining a frame of reference to keep a mixed reality hologram (e.g., virtual information) located in an assigned position. The virtual information of the mixed reality hologram can correspond to a device in building 100. Each device in building 100 can include a unique spatial anchor.

Since each device in building 100 includes a unique spatial anchor, mixed reality computing device 102 can determine which device it has located (e.g., and the corresponding virtual information about the device to display) among the devices in the building 100 based on the spatial anchor of that device. For example, device 104 may be a controller included in a panel, where the panel includes five total controllers. Each of the five controllers included in the panel can include a unique and different spatial anchor such that the mixed reality computing device 102 can display virtual information corresponding to the controller of interest (e.g., device 104).

As is further described herein, mixed reality computing device 102 can display a 3D representation of device 104 on the transparent display of mixed reality computing device 102 that is located in a position and orientation corresponding to the physical device 104 in the physical environment of Room 1 of building 100. The spatial anchor of device 104 can further function to keep the position and orientation of the 3D representation of device 104 static as the field of view 110 of mixed reality computing device 102 changes so that the user of mixed reality computing device 102 is not confused as to where the physical device 104 is located in the physical environment of Room 1.

As described above, mixed reality computing device 102 can determine its location in building 100. Additionally, mixed reality computing device 102 can receive the work order from the BMS of building 100 that includes a location of device 104. In some examples, mixed reality computing device 102 can determine that its location is different from the location of device 104 included in the work order. In such an example, mixed reality computing device 102 can display directions 112 to direct a user to device 104, as is further described herein.

In some examples, the mixed reality computing device 102 can determine its location is different than the location of device 104 based on mixed reality computing device 102 detecting a spatial anchor that is not associated with the device 104 included in the work order. For example, mixed reality computing device 102 can detect a spatial anchor of an object included in Room 2, where the detected spatial anchor of the object in room 2 does not correspond to the spatial anchor of device 104. Based on the detected spatial anchor of the device in Room 2, mixed reality computing device 102 can determine its location is different from the location of device 104.

Based on the determination of the location of mixed reality computing device 102 (e.g., Room 2), the mixed reality computing device 102 can display directions 112 from initial location 108 to location 106. For example, as illustrated in FIG. 1, mixed reality computing device 102 can include an initial location 108, indicated in FIG. 1 by the dotted square located in Room 2 of building 100. Since the mixed reality computing device 102 knows the location of the device due to the detected spatial anchor in Room 2, and where the spatial anchor corresponding to device 104 is located (e.g., as included in the predetermined model), mixed reality computing device 102 can generate and display directions 112 from initial location 108 to location 106.

The directions 112 can be displayed on the transparent display of mixed reality computing device 102. For example, the displayed directions 112 on the transparent display can include an arrow and a dotted line to point the user in a first direction towards the Hallway and out of Room 2 of building 100, and from the Hallway into Room 1, and to turn left once in Room 1 to locate device 104. The displayed directions 112 can be virtually displayed on the transparent display, overlaid over the physical environment of building 100. Accordingly, the user can view the physical environment of building 100 through the transparent display while simultaneously viewing the virtually displayed directions 112 on the transparent display as the user moves through building 100. The virtually displayed directions 112 can update in real-time as the user moves from Room 2 to Room 1.

Mixed reality computing device 102 can display virtual information about device 104 based on the location 106 of mixed reality computing device 102 and a location of device 104 in building 100. For example, mixed reality computing device 102 can (e.g., may only) display virtual information about device 104 in response to the location 106 of mixed reality computing device 102 and the location of device 104 being the same (e.g., mixed reality computing device 102 may not display virtual information about device 104 if the location 106 of mixed reality computing device 102 is different than the location of device 104). For instance, mixed reality computing device 102 can determine that mixed reality computing device 102 is in a same room as device 104. As a result, mixed reality computing device 102 can display virtual information about device 104.

The virtual information can include information about fixing a fault of device 104. For example, the work order for device 104 that is received by mixed reality computing device 102 can indicate that device 104 has a fault. As used herein, the term “fault” refers to an event that occurs to cause a piece of equipment to function improperly or to cause abnormal behavior in a building. In some examples, a fault can include a piece of equipment breaking down. In some examples, a fault can include a component of a piece of equipment ceasing to function correctly. In some examples, a fault can include abnormal behavior of a piece of equipment and/or an area.

Although a fault is described as including equipment breakdowns and abnormal behavior, embodiments of the present disclosure are not so limited. For example, faults can include any other event that causes equipment to function improperly, and/or causes abnormal behavior to occur in a building.

Virtual information can further include device information. For example, device 104 can be an AHU. The AHU can include a type of AHU (e.g., a chiller), a model of the AHU, and/or a serial number of the AHU, among other types of device information.

Virtual information can include wiring diagrams for device 104. For example, device 104 can include electrical circuits, electrical connections, and/or other electrical components. A wiring diagram for device 104 can be included in the virtual information such that a user can utilize the wiring diagram for various purposes, such as for troubleshooting, maintenance, testing, etc.

Virtual information can include user manuals for device 104. For example, device 104 can include a user manual, which can explain operating steps for device 104, operating parameters of device 104, safety information for device 104, etc.

Virtual information can include safety information for device 104. For example, different types of safety equipment may be utilized when working with different devices 104. For instance, electrical safety equipment may be specified when a work order includes tasks involving electricity, harnesses may be specified when a work order includes a device which is located above the ground, etc.

Virtual information can include operating information of the device 104. For example, real-time sensor values (e.g., real-time temperature) can be included in the virtual information. Other types of operating information of device 104 can include set-points of various equipment, etc.

As described above, mixed reality computing device 102 can display virtual information about device 104 in response to the location 106 of mixed reality computing device 102 and the location of device 104 being the same. In some examples, the location 106 of mixed reality computing device 102 is the same location as device 104 if it is within a predetermined distance from device 104. For example, if mixed reality computing device 102 is within the predetermined distance (e.g., 5 meters), mixed reality computing device 102 can display virtual information about device 104.

In some examples, mixed reality computing device 102 can display virtual information about device 104 in response to device 104 being located within the field of view 110 of mixed reality computing device 102. As used herein, the term “field of view” refers to an observable area mixed reality computing device 102 can view via the optical sensor (e.g., the camera) of mixed reality computing device 102. For example, when device 104 is located with the observable area of the camera of mixed reality computing device 102, mixed reality computing device 102 can display virtual information about device 104.

The virtual information can be can be displayed on the transparent display of mixed reality computing device 102. For example, the virtual information displayed on the transparent display can include information about fixing a fault of device 104, including device information, wiring diagrams, user manuals, safety information, operating information, among other types of virtual information. The displayed virtual information can be virtually displayed on the transparent display, overlaid over the physical environment of building 100. That is, the user can view the physical environment of building 100 through the transparent display while simultaneously viewing the virtually displayed virtual information on the transparent display. The virtual information can update in real-time.

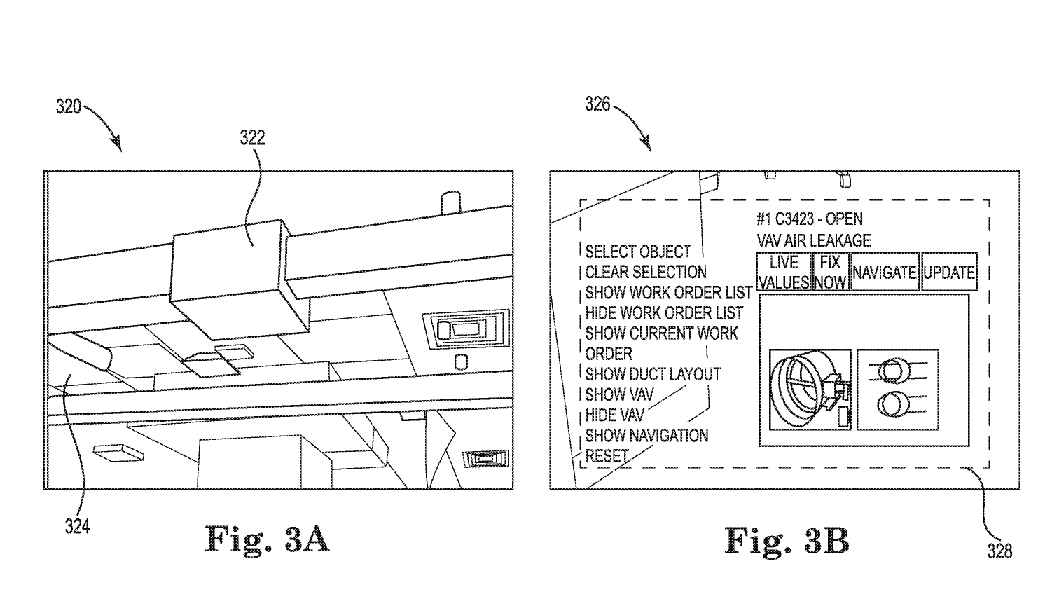

In some examples, the device 104 may be obstructed by an obstacle in Room 1 of building 100. For example, device 104 may be a variable air volume (VAV) device located above ceiling panels so that it is not visible to a normal occupant of Room 1 of building 100. Nonetheless, mixed reality computing device 102 can display virtual information about device 104, information about fixing a fault of device 104, and/or display a 3D representation of device 104 via the transparent display of mixed reality computing device 102, as is further described in connection with FIGS. 3A and 3B, regardless of device 104 being obstructed by an obstacle.

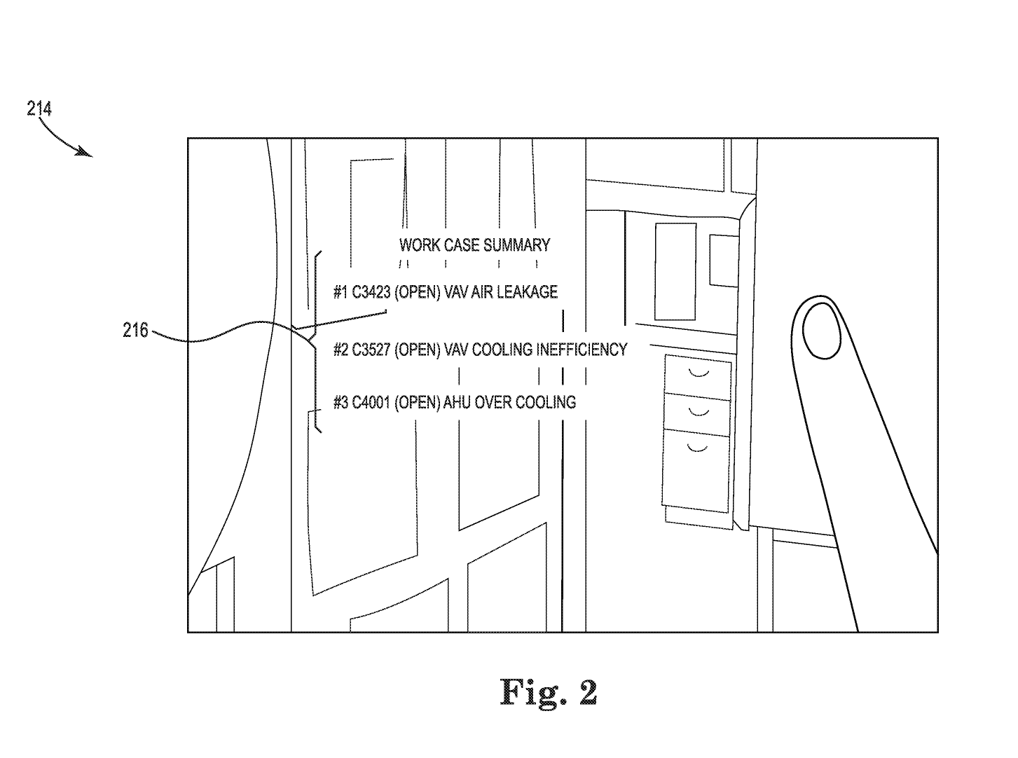

FIG. 2 illustrates an example of a mixed reality display 214, in accordance with one or more embodiments of the present disclosure. As illustrated in FIG. 2, mixed reality display 214 can include list of work orders 216. Mixed reality display 214 can be displayed by, for example, mixed reality computing device 102, described in connection with FIG. 1.

As previously described in connection with FIG. 1, the mixed reality computing device can receive a work order from a BMS. In some instances, the user utilizing the mixed reality computing device may work in a large facility and as a result, may receive multiple work orders for a particular time period (e.g., a particular day).

In the example illustrated in FIG. 2, the mixed reality computing device has received three work orders that are displayed as a list 216 of work orders. The list 216 of work orders can be displayed on the transparent display of the mixed reality computing device. For example, as illustrated in FIG. 2, the displayed list 216 can be virtually displayed on the transparent display, overlaid over the physical environment of the building. The user of the mixed reality computing device can view the physical environment in which they are located while simultaneously viewing the list 216 of work orders.

The list 216 of work orders can include three work orders which can each include various details. The first work order (e.g., #1) can include a work order number (e.g., C3424), a work order status of OPEN, and a predicted fault (e.g., VAV AIR LEAKAGE). Similarly, the second work order (e.g., #2) can include work order number C3527, a work order status of OPEN, and a predicted fault (e.g., VAV COOLING INEFFICIENCY), and the third work order (e.g., #3) can include work order number C4001, a work order status of OPEN, and a predicted fault (e.g., AHU OVER COOLING).

Although the list 216 of work orders is illustrated as including three work orders, embodiments of the present disclosure are not so limited. For example, the list 216 can include more than three work orders or less than three work orders.

In some examples, the list 216 of work orders can be user specific. For example, the mixed reality computing device may be utilized by different users. A first user may have a list of two work orders, while a second user may have the list 216 of three work orders. The mixed reality computing device can display the list of two work orders when the first user is using the mixed reality computing device, and display the list 216 of three work orders when the second user is using the mixed reality computing device.

FIG. 3A illustrates an example of a mixed reality display 320 including a device 322, in accordance with one or more embodiments of the present disclosure. As illustrated in FIG. 3A, mixed reality display 320 can include a device 322 and an obstacle 324. Mixed reality display 320 can be displayed by, for example, mixed reality computing device 102, described in connection with FIG. 1

The mixed reality computing device can display a 3D representation of device 322 on the mixed reality display. The 3D representation illustrated in FIG. 3A can be a VAV device. The 3D representation can be shaped to be a same shape as the physical VAV device. For example, the physical VAV device may be shaped generally as a rectangular prism, and the 3D representation can be correspondingly shaped as a rectangular prism.

Although the 3D representation is described above as being a rectangular prism, embodiments of the present disclosure are not so limited. For example, the 3D representation can be a prism of any other shape (e.g., rectangular, square, cuboid, cylindrical, and/or more complex shapes such as star prisms, crossed prisms, toroidal prisms, and/or any other 3D shape).

As illustrated in FIG. 3A, the device 322 may be located behind an obstacle 324. The obstacle 324 illustrated in FIG. 3A can be ceiling panels. For example, in the physical environment, device 322 may be located behind the ceiling panels such that device 322 may not be normally observable (e.g., without removing the ceiling panels). However, the 3D representation of device 322 can be displayed on the transparent display of the mixed reality computing device, even though device 322 is behind obstacle 324.

For example, the 3D representation of device 322 can be displayed on the transparent display of the mixed reality computing device overlaid over the physical environment of the building. For instance, the user can still view the ceiling panels, but can also view the 3D representation of device 322, as well as its location and/or devices that may be associated with and/or connected to device 322. For instance, as illustrated in FIG. 3A, 3D representations of duct work connected to VAV device 322 may also be displayed on the transparent display of the mixed reality computing device.

The 3D representation of device 322 can be displayed on the transparent display of the mixed reality computing device when device 322 is in the field of view of the mixed reality computing device. For example, when a user enters the space including device 322, device 322 may not be displayed on the transparent display since the user is not looking in the direction of device 322, or may not be in the correct area of the space including device 322, etc. When the user is looking in the direction of the device 322 such that device 322 is in the field of view of the mixed reality computing device, the 3D representation of device 322 can be displayed on the transparent display.

As previously described in connection with FIG. 1, the 3D representation of device 322 can include a spatial anchor. The spatial anchor can keep the position and orientation of the 3D representation of VAV device 322 static. For example, as the user of the mixed reality computing device looks around the physical environment, the field of view of the mixed reality computing device can change, resulting in the position of device 322 as viewed from the perspective of the user through the transparent display changing as a result of the position of device 322 changing within the field of view of the mixed reality computing device. The spatial anchor can keep the position and orientation of the 3D representation of VAV device 322 the same relative to the physical environment. As a result, the 3D representation of VAV device 322 may change position on the transparent display of the mixed reality computing device as the user moves but stays in the same location relative to the physical environment in which the mixed reality computing device is located. This can allow the user to determine the location of the VAV device 322 in the physical environment, even if the VAV device 322 is not normally visible (e.g., is obstructed from sight by an obstacle 324).

Although the obstacle 324 is described above as being a ceiling panel, embodiments of the present disclosure are not so limited. For example, the obstacle 324 can be any other obstacle that can obstruct a view of a device. For instance, the obstacle can include a wall, a panel, a cover, an access door, etc.

FIG. 3B illustrates an example of a mixed reality display 326 including displayed virtual information 328, in accordance with one or more embodiments of the present disclosure. As illustrated in FIG. 3B, the mixed reality display 326 can include displayed virtual information 328. Mixed reality display 326 can be displayed by, for example, mixed reality computing device 102, described in connection with FIG. 1

The displayed virtual information 328 can be displayed on the transparent display of the mixed reality computing device. For example, the displayed virtual information 328 can be overlaid over the physical environment of the building. That is, the user can view the physical environment of the building while simultaneously viewing the displayed virtual information 328 on the transparent display.

The displayed virtual information 328 can include information about fixing a predicted fault of a device. For instance, the mixed reality computing device can receive a work order about a particular device, and the work order can include a fault that the device may have experienced. The displayed virtual information 328 can include information about fixing the fault that the device may have experienced. The virtual information 328 can be displayed on the mixed reality display in response to the location of the mixed reality computing device being in the same location as the device corresponding to the received work order.

As illustrated in FIG. 3B, the displayed virtual information 328 can be for work order #1 (e.g., previously described in connection with FIG. 2) describing a VAV air leakage. The displayed virtual information 328 can include diagrams of the VAV device, including air flow diagrams. Further, the displayed information 328 can include various menu options, including selection of an object, clear the selection, show/hide work order lists, show current work, show duct layout, hide duct layout, show VAV, hide VAV, show navigation, and reset, among other types of menu options. A user may select these various options when determining how to perform tasks to satisfy the received work order regarding the VAV device. A user may also utilize other options, such as viewing live values, marking fix now to indicate a work order is satisfied, navigate to the device and/or to other areas, and to update the displayed information, among other types of options.

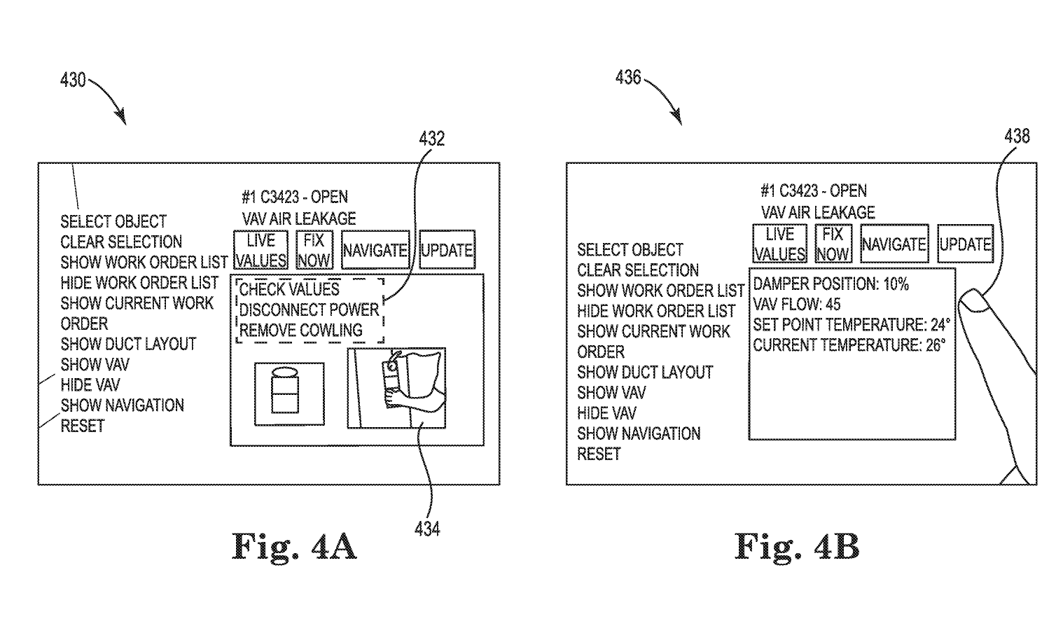

Utilizing the transparent display as described in connection with FIGS. 3A and 3B, a user can locate a device included in a work order. Further, the user can view different information about the device, including information about the predicted fault of the device, in order to perform tasks to complete the work order. The work order may include steps of a standard operating procedure a user can follow to complete the work order, as is further described in connection with FIG. 4A.

FIG. 4A illustrates an example of a mixed reality display 430 including steps 432 of a standard operating procedure (SOP), in accordance with one or more embodiments of the present disclosure. As illustrated in FIG. 4A, mixed reality display 430 can include steps 432 of the SOP and video tutorial 434. Mixed reality display 430 can be displayed by, for example, mixed reality computing device 102, described in connection with FIG. 1

As the user arrives at the device to begin the tasks included in the work order for the device, in some examples the transparent display can display a 3D representation of the device (e.g., previously described in connection with FIG. 3A), display virtual information about the device (e.g., previously described in connection with FIG. 3B), and, as is further described herein, steps of an SOP. The user can utilize these displayed items to complete various tasks associated with a work order for a device.

As used herein, the term “SOP” refers to a set of step-by-step instructions to carry out a series of operations. The instructions can be performed to carry out, for example, a work order. In other words, the work order can be accomplished by the user by performing a series of step-by-step instructions included in an SOP.

Various work orders may include different SOPs. For example, the work order #1 having the open VAV air leakage can include a different SOP than work order #2 corresponding to a VAV cooling inefficiency (e.g., previously described in connection with FIG. 2).

In other words, the information about fixing the fault of the device (e.g., the VAV device) can include steps of an SOP corresponding to the fault. As illustrated in FIG. 4A, steps 432 of the SOP corresponding to a VAV air leakage an include a first step of checking values, a second step of disconnecting power, a third step of removing a cowling, etc. The steps 432 are steps a user utilizing the mixed reality computing device can follow in order to complete various tasks associated with the work order. The steps 432 can be virtually displayed on the transparent display, overlaid over the physical environment of the building. That is, the user can view the physical environment of the building through the transparent display while simultaneously viewing the steps 432 on the transparent display.

Although three steps 432 are illustrated in FIG. 4A as being displayed on the transparent display, embodiments of the present disclosure are not so limited. For example, steps 432 can include all of the steps of an SOP and can be dynamically updated/changed on the transparent display as the user completes each step. For example, as a user completes a step, the user can indicate as such, as is further described in connection with FIG. 4B, causing updated steps 432 to be displayed on the transparent display.

In some examples, a video tutorial 434 can be displayed on the transparent display. For example, one user may be less skilled at a particular work order than other users, may have less technical ability, less technical experience, etc. As a result, a user may not fully understand a step of, or the steps of the SOP. Utilizing the mixed reality computing device, the user can view a video tutorial 434 of the steps 432 of the SOP. For example, the video tutorial 434 can provide a set of instructions with corresponding visual examples for the user to utilize in order to understand the steps 432 of the SOP. As an example, the user may not understand how to remove the cowling from the VAV device from the steps 432 of the SOP. The video tutorial 434 can provide the user with a visual example of how to remove the cowling from the VAV device in order to assist the user with the steps 432 of the SOP. The user can view the physical environment of the building through the transparent display while simultaneously viewing the video tutorial 434 on the transparent display.

Although not illustrated in FIG. 4A for clarity and so as not to obscure embodiments of the present disclosure, a live video assistance in a picture-in-picture orientation can be displayed on the transparent display. For example, a user may have questions or want assistance with a particular task or step included in steps 432 of SOP.

The user can utilize a live video assistance via the transparent display. For example, another technician, engineer, or other user who may be in a location remote from the location of the mixed reality computing device can connect to the mixed reality computing device and provide live video assistance to the user. For example, the user may not understand how to remove the cowling from the VAV device from the steps 432 of the SOP. Another technician can connect to the mixed reality computing device to explain and/or show the user how to remove the cowling from the VAV device. The technician can be displayed on the transparent display in a video viewable by the user of the mixed reality computing device. The technician can, in some examples, view what the user of the mixed reality computing device views via the optical sensor of the mixed reality computing device. The user can view the physical environment of the building through the transparent display while simultaneously viewing the live video assistance on the transparent display.

FIG. 4B illustrates an example of a mixed reality display 436 including updating the steps of the SOP, in accordance with one or more embodiments of the present disclosure. As illustrated in FIG. 4B, the mixed reality display 436 can include a gesture input 438. Mixed reality display 436 can be displayed by, for example, mixed reality computing device 102, described in connection with FIG. 1

As a user is performing tasks in the SOP, the user can update a checklist. The checklist can document the steps the user has performed as the steps of the SOP are completed. For example, when the user removes the cowling from a VAV device, the user can update the checklist to document the step of the SOP to remove the cowling from the VAV device has been completed.

As illustrated in FIG. 4B, a user can utilize a gesture input 438 to update the checklist. For example, the optical sensor of the mixed reality computing device can detect movements within its field of view. The movements can include a gesture input 438 such as, for instance, gesturing with a hand or finger. As an example, a user can swipe a finger to the left or right to update a checklist of an SOP. Additionally, although the gesture input 438 is described as a finger swipe by a user, embodiments of the present disclosure are not so limited. For example, the user can perform any other type of gesture.

Although not illustrated in FIG. 4B for clarity and so as not to obscure embodiments of the present disclosure, a user can provide a voice input to the mixed reality computing device to update the checklist. For instance, the mixed reality computing device may include one or more microphones. In some examples, the microphones may receive audio input from a user and/or audio input from a physical environment around the user. As an example, a user can audible speak a word to indicate a step of the SOP is completed and therefore to update the checklist.

In some examples, the user can cause the mixed reality computing device to update a checklist of an SOP in response to a gesture, a gaze, a voice command, and/or a combination thereof.

Building system maintenance using mixed reality can allow a user to easy receive work orders, locate devices in a building which may be unfamiliar to them, and perform steps of an SOP to complete work orders of the devices in the building. The mixed reality computing device can allow a user who may be unfamiliar with a building or with a particular device included in a work order to complete installation, maintenance, and/or repairs of devices in a building. Integrated video tutorials and live video support can provide a user of the mixed reality computing device with further information to complete a work order without causing additional resources to be committed to the work order which can allow a user to complete work orders on a variety of different devices in a variety of different locations, saving time, cost, and labor.

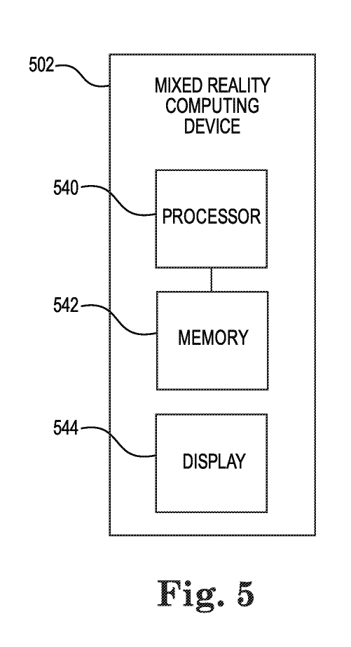

FIG. 5 illustrates an example mixed reality computing device 502 for building system maintenance using mixed reality, in accordance with one or more embodiments of the present disclosure. Mixed reality computing device 502 can be, for example, a mobile device having a display 544. The display 544 can be a transparent display and can be a head mounted display, a handheld display, or a spatial display, among other types of mixed realty devices.

As shown in FIG. 5, mixed reality computing device 502 includes a memory 542 and a processing resource 540 (e.g., processor) coupled to memory 542. Memory 542 can be any type of storage medium that can be accessed by processor 540 to perform various examples of the present disclosure. For example, memory 542 can be a non-transitory computer readable medium having computer readable instructions (e.g., computer program instructions) stored thereon that are executable by processor 540 to perform building system maintenance using mixed reality in accordance with one or more embodiments of the present disclosure.

Memory 542 can be volatile or nonvolatile memory. Memory 542 can also be removable (e.g., portable) memory, or non-removable (e.g., internal) memory. For example, memory 542 can be random access memory (RAM) (e.g., dynamic random access memory (DRAM) and/or phase change random access memory (PCRAM)), read-only memory (ROM) (e.g., electrically erasable programmable read-only memory (EEPROM) and/or compact-disc read-only memory (CD-ROM)), flash memory, a laser disc, a digital versatile disc (DVD) or other optical disk storage, and/or a magnetic medium such as magnetic cassettes, tapes, or disks, among other types of memory.

Further, although memory 542 is illustrated as being located in mixed reality computing device 502, embodiments of the present disclosure are not so limited. For example, memory 542 can also be located internal to another computing resource (e.g., enabling computer readable instructions to be downloaded over the Internet or another wired or wireless connection).

As shown in FIG. 5, mixed reality computing device 502 can also include a display 544. Display 544 can be, for example, a transparent mixed reality display (e.g., a screen). The transparent mixed reality display can be, for instance, a touch-screen (e.g., the mixed reality display can include touch-screen capabilities). Display 544 (e.g., the transparent mixed reality display) can provide (e.g., display and/or present) information to a user of mixed reality computing device 502.

Additionally, mixed reality computing device 502 can receive information from the user of mixed reality computing device 502 through an interaction with the user via a user interface. For example, mixed reality computing device 502 can receive input from the user via, for instance, voice commands, physical gestures, gazing, or by touching the display 544 in embodiments in which the display 544 includes touch-screen capabilities (e.g., embodiments in which the display is a touch screen).

Although specific embodiments have been illustrated and described herein, those of ordinary skill in the art will appreciate that any arrangement calculated to achieve the same techniques can be substituted for the specific embodiments shown. This disclosure is intended to cover any and all adaptations or variations of various embodiments of the disclosure.

It is to be understood that the above description has been made in an illustrative fashion, and not a restrictive one. Combination of the above embodiments, and other embodiments not specifically described herein will be apparent to those of skill in the art upon reviewing the above description.

The scope of the various embodiments of the disclosure includes any other applications in which the above structures and methods are used. Therefore, the scope of various embodiments of the disclosure should be determined with reference to the appended claims, along with the full range of equivalents to which such claims are entitled.

In the foregoing Detailed Description, various features are grouped together in example embodiments illustrated in the figures for the purpose of streamlining the disclosure. This method of disclosure is not to be interpreted as reflecting an intention that the embodiments of the disclosure require more features than are expressly recited in each claim.

Rather, as the following claims reflect, inventive subject matter lies in less than all features of a single disclosed embodiment. Thus, the following claims are hereby incorporated into the Detailed Description, with each claim standing on its own as a separate embodiment.

1. A mixed reality computing device for building system maintenance, comprising:
a transparent mixed reality display through which a user can view a physical environment in which the user is located;
a memory; and
a processor configured to execute instructions stored in the memory to:
receive a work order for a device in a building from a remote device;
display two or more steps of a checklist of a standard operating procedure (SOP) for fixing the device on the transparent mixed reality display while simultaneously allowing a user to view the physical environment through the transparent mixed reality display;
receive a voice command, a gesture and/or a gaze from the user indicating a current step of the checklist has been completed; and
dynamically update the checklist on the transparent mixed reality display in response to the voice command, the gesture and/or the gaze from the user.

2. The mixed reality computing device of claim 1, wherein the processor is configured to execute the instructions to display the two or more steps of the checklist of the standard operating procedure (SOP) for fixing the device on the transparent mixed reality display in response to the device being located in the field of view of the mixed reality computing device.

3. The mixed reality computing device of claim 1, wherein the processor is configured to execute the instructions to:
determine a location of the mixed reality computing device in the building; and
display directions to direct a user from the location of the transparent mixed reality computing device to the device.

4. The mixed reality computing device of claim 1, wherein the processor is configured to execute instructions to display a three-dimensional (3D) representation of the device on the transparent mixed reality display.

5. The mixed reality computing device of claim 1, wherein the received work order includes details of the work order, and wherein the processor is configured to execute the instructions to display at least some of the details of the work order over a portion of the area of the transparent mixed reality display.

6. The mixed reality computing device of claim 3, wherein the processor is configured to execute the instructions to determine the location of the mixed reality computing device in the building using spatial analytics.

7. The mixed reality computing device of claim 3, wherein the processor is configured to execute the instructions to determine the location of the device in the building using a spatial anchor.

8. A mixed reality computing device for building system maintenance, comprising:
a transparent mixed reality display through which a user can view a physical environment in which the user is located;
a memory; and
a processor configured to execute instructions stored in the memory to:
receive a work order for a heating, ventilation, and air conditioning (HVAC) device in a building from a building management system of the building;
determine a location of the mixed reality computing device in the building;
determine a location of the HVAC device in the building;
display two or more steps of a checklist of a standard operating procedure (SOP) for fixing the HVAC device on the transparent mixed reality display while simultaneously allowing a user to view the physical environment through the transparent mixed reality display; and
receive a voice command and/or a gesture from the user indicating a current step of the checklist has been completed, and in response, dynamically update the checklist on the transparent mixed reality display.

9. The mixed reality computing device of claim 8, wherein the processor receives a voice command from the user indicating the current step of the checklist has been completed, and in response, dynamically updates the checklist on the transparent mixed reality display.

10. The mixed reality computing device of claim 9 further comprising a microphone for receiving the voice command and providing the voice command to the processor.

11. The mixed reality computing device of claim 8, wherein the processor receives a gesture from the user indicating the current step of the checklist has been completed, and in response, dynamically updates the checklist on the transparent mixed reality display.

12. The mixed reality computing device of claim 8, wherein the standard operating procedure (SOP) includes steps for fixing a predicted fault of the HVAC device.

13. The mixed reality computing device of claim 8, wherein the processor is configured to execute the instructions to display the two or more steps of the checklist of the standard operating procedure (SOP) for fixing virtual information about the HVAC device on the transparent mixed reality display in response to the HVAC device being at least in a same room of the building as the mixed reality computing device.

14. The mixed reality computing device of claim 8, wherein the processor is configured to execute the instructions to display directions to the HVAC device from the location of the mixed reality computing device in the building in response to the location of the mixed reality computing device in the building and the location of the HVAC device in the building being different.

15. The mixed reality computing device of claim 8, wherein the processor is configured to execute the instructions to display a three-dimensional (3D) representation of the HVAC device on the transparent mixed reality display in response to:
the HVAC device being located in the field of view of the mixed reality computing device; and
the HVAC device being obstructed from sight of the mixed reality computing device by an obstacle.

16. A method for building system maintenance, comprising:
receiving, by a mixed reality computing device, a work order for a heating, ventilation, and air conditioning (HVAC) device in a building, the work order specifying a fault of the HVAC device;
determining, by the mixed reality computing device:
a location of the mixed reality computing device in the building using spatial analytics;
a location of the HVAC device in the building using a spatial anchor that is unique to the HVAC device;
displaying, on a transparent mixed reality display of the mixed reality computing device, two or more steps of a checklist of a standard operating procedure (SOP) for fixing the fault of the HVAC device while simultaneously allowing a user to view the physical environment through the transparent mixed reality display;
receiving a voice command and/or a gesture from the user indicating a current step of the checklist has been completed; and
dynamically updating the checklist on the transparent mixed reality display in response to the voice command and/or the gesture from the user.

17. The method of claim 16, wherein determining the location of the mixed reality computing device using spatial analytics includes analyzing a video feed of a camera of the mixed reality computing device.

18. The method of claim 17, wherein determining the location of the mixed reality computing device using spatial analytics includes comparing the video feed of the camera with a predetermined model of the building located in a remote server.

19. The method of claim 16, wherein the method includes displaying, on the transparent mixed reality display, a video tutorial of at least one of the steps of the SOP.

20. The method of claim 16, wherein the method includes displaying, on the transparent mixed reality display, live video assistance for the work order in a picture-in-picture orientation on the transparent mixed reality display.
